(19) United States
(12) Patent Application Publication
(10) Pub. No.: US 2022/0169037 A1
(43) Pub. Date: Jun. 2, 2022

(54) Printer Color Calibration Via A Monochromatic Sensor

(71) Applicant: Hewlett-Packard Development Company, L.P., Spring, TX (US)

(72) Inventor: Miguel Angel Lopez Alvarez, Vancouver, WA (US)

(73) Assignee: Hewlett-Packard Development Company, L.P., Spring, TX (US)

(21) Appl. No.: 17/433,000

(22) PCT Filed: Jul. 3, 2019
(86) PCT No.: PCT/US2019/040614

§ 371 Date: Aug. 23, 2021

(51) Int. Cl. B41J 2/32; H04N 1/60; B41J 2/525

(52) U.S. Cl. CPC B41J 2/32; B41J 2/525; H04N 1/6044

(57) ABSTRACT

A multicolor thermal printer comprising a controller, a thermal printhead, multicolor thermal paper, a monochrome lightness sensor, and a calibration subsystem is described. The calibration subsystem prints a calibration target that is scanned by the monochrome lightness sensor to determine if color crosstalk is present. If color crosstalk is present, the calibration subsystem decreases the contone range of affected colors and saves the new calibration settings.

### BACKGROUND

Users of smartphones and/or other devices containing cameras often find it desirable to share printed color copies of captured images. Acceptable image quality is obtainable using multicolor thermal paper and printer technology employing thermal printheads. However, the variability of multicolor thermal paper and/or thermal printhead characteristics, introduced during manufacturing, may degrade image quality.

Calibration techniques may be employed to compensate for manufacturing variability and improve image quality. Calibration techniques may include the evaluation of calibration targets and/or user images. If calibration is necessary, adjustments are made, and the new calibration data may be saved for future use.

### BRIEF DESCRIPTION OF THE DRAWINGS

The written disclosure herein describes illustrative examples that are nonlimiting and non-exhaustive. Reference is made to certain of such illustrative examples that are depicted in the figures described below.

FIG. 1 illustrates an example multicolor thermal printer system comprising multicolor thermal paper, thermal printhead, monochrome lightness sensor, controller, and/or calibration subsystem.

FIG. 2 illustrates an example multicolor thermal printer system that has moved the multicolor thermal paper to the right and completed printing on the first five rows of the multicolor thermal paper.

FIG. 3 illustrates an example of a cross-section and the surface of a sheet of multicolor thermal paper and a multiplicity of colors printed on it.

FIG. 4 illustrates an example calibration target with a set of color patches of different discrete contones of each of a plurality of colors.

FIG. 5 illustrates an example of monochrome lightness values of each color patch of a calibration target.

FIG. 6 illustrates an example of monochrome lightness values of each color patch of a calibration target where color crosstalk occurs.

FIG. 7 illustrates an example process to calibrate a multicolor thermal printing system to improve image quality using a calibration target.

FIG. 8 illustrates an example process to calibrate a multicolor thermal printing system to improve image quality using an image.

### DETAILED DESCRIPTION

Users of smartphones and/or other devices containing cameras often find it desirable to share printed color copies of captured images. Acceptable image quality is obtainable using multicolor thermal paper and printer technology employing thermal printheads. However, the variability of multicolor thermal paper and/or thermal printhead characteristics, introduced during manufacturing, may degrade image quality. Calibration techniques may be employed to compensate for manufacturing variability and improve image quality.

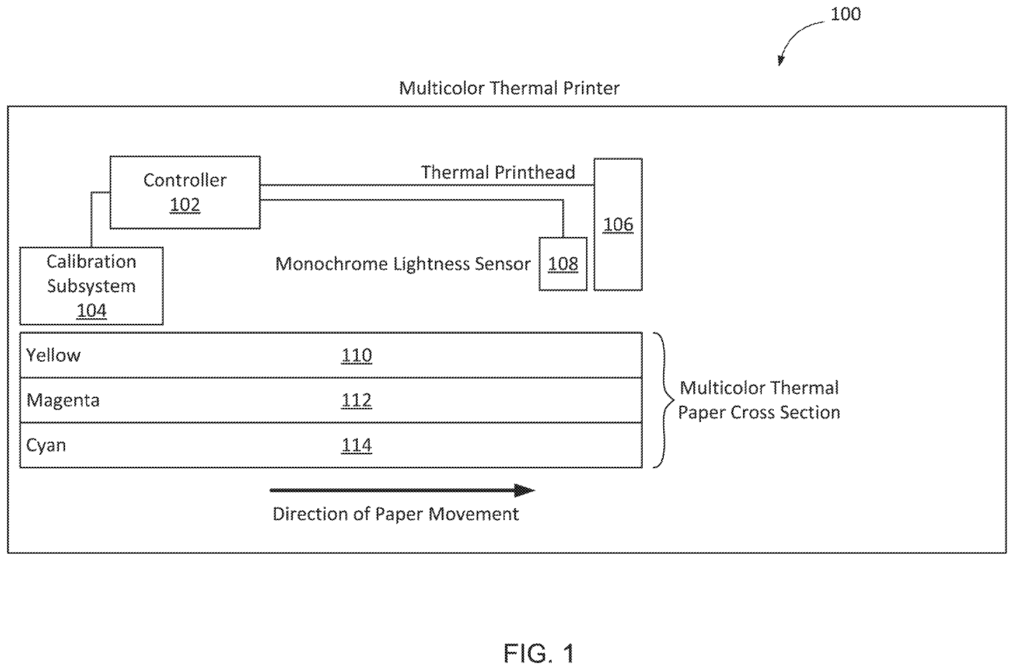

FIG. 1 illustrates an example multicolor thermal printer system 100 comprising multicolor thermal paper, a thermal printhead 106, a monochrome lightness sensor 108, a controller 102, and a calibration subsystem 104. In the illustrated example, the multicolor thermal paper has layers of thermally activated dyes. The multicolor thermal paper includes a yellow layer 110, a magenta layer 112, and a cyan layer 114. Each layer is transparent or translucent until thermally activated. In this example, the multicolor thermal paper moves from left to right under the thermal printhead 106. In various examples, the thermal printhead 106 and/or the multicolor thermal paper may move.

In some examples, there is a monochrome lightness sensor 108 positioned on the same side of the paper as the thermal printhead 106. The position of the monochrome lightness sensor 108 enables the monochrome lightness sensor 108 to measure the monochrome lightness values of areas of a printed image. In the illustrated example, the controller 102 controls the multicolor thermal printer system 100. The calibration subsystem 104 interacts with the controller 102 to improve image quality.

In some examples, the position of a monochrome lightness sensor 108 may be on the same side of the paper as the thermal printhead 106. In these examples, the monochrome lightness sensor 108 may measure the monochrome lightness values of the printed image during the printing process before the multicolor thermal paper is fully ejected from the printer. In other examples, the monochrome lightness sensor 108 may be on the opposite side of the paper from the thermal printhead 106. In these examples, printed multicolor thermal paper may be reloaded in the printer upside down to allow for the paper to be ejected from the printer a second time, during which the monochrome lightness sensor 108 can measure the monochrome lightness values of the printed image.

In some examples, the monochrome lightness sensor 108 may be a remote component not physically attached to the multicolor thermal printer system 100. In some examples, the multicolor thermal printer system 100 may utilize a lightness sensor or another type of sensor capable of measuring color values. For example, a 3-channel (e.g., RGB sensors) sensor may be utilized to read the color patches. A multi-channel sensor could be used to measure lightness (similar to some of the other examples described herein), chroma, and/or hue. The calibration subsystem 104 may utilize the measured lightness, chroma, and/or hue from a multi-channel sensor to detect color crosstalk. For example, the multi-channel sensor can detect red turning black based on a change in chroma. Similarly, a multi-channel sensor can be used to detect an expected yellow color patch having the wrong hue (e.g., turning orange). Thus, the systems and methods described herein for comparing lightness values captured by a single-channel sensor can be extended for multi-channel sensors detecting changes in chroma and/or hue in the same manner. That is, deviations from expected lightness, chroma, and/or hue values can be used to identify crosstalk between colorant layers in the multicolor thermal paper.

When thermally activated, the dye in the yellow layer 110 adopts a tone of the color yellow. Similarly, when thermally activated, the dye in the magenta layer 112 adopts a tone of the color magenta. Likewise, when thermally activated, the dye in the cyan layer 114 adopts a tone of the color cyan.

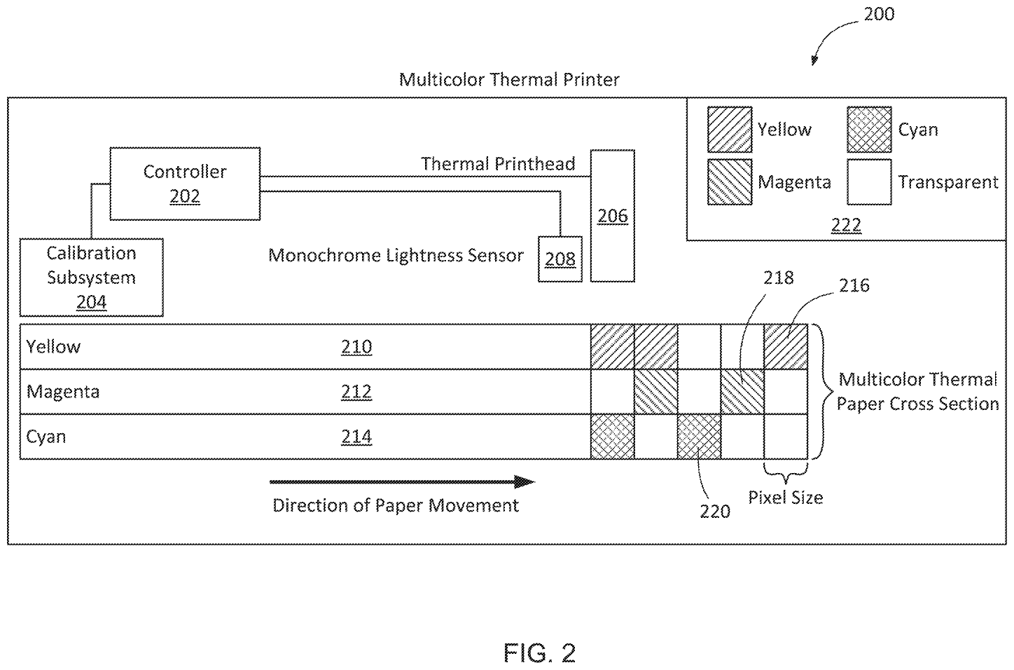

FIG. 2 illustrates an example multicolor thermal printer system 200 that has moved the multicolor thermal paper to the right and completed printing on the first five rows of the multicolor thermal paper. Printing is accomplished by activating dyes in the desired layers 210, 212, and 214 of the multicolor thermal paper. The printhead 206 activates dyes in the yellow layer 210 by applying a high temperature for a short period, resulting in an area 216 with a yellow tone as described by the legend 222. The printhead 206 may selectively activate each different layer 210, 212, and 214 by, for example, applying specific temperatures for varying amounts of time. For example, the printhead 206 may active dyes in the magenta layer 212 by applying a medium temperature for a medium period, resulting in an area 218 with a magenta tone. Similarly, the printhead 208 may activate dyes in the cyan layer 214 by applying a lower temperature for a longer period, resulting in an area 220 with a cyan tone. In other examples, the printhead 206 may apply a common, pulse-width modulated temperature at different pulse widths to active different layers. For example, the thermal printhead 206 may activate a yellow layer by applying heat at a first temperature and a first pulse width. To activate the cyan layer, the thermal printhead may apply the same first temperature, but use different pulse widths.

In the illustrated example, a controller 202 controls the multicolor thermal printer system 200. The calibration subsystem 204 interacts with the controller 202 to improve image quality. A monochrome lightness sensor 208 is positioned on the same side of the multicolor thermal paper as the thermal printhead 206. The position of the monochrome lightness sensor 208 enables the monochrome lightness sensor 208 to measure the lightness of areas of an image printed on the multicolor thermal paper.

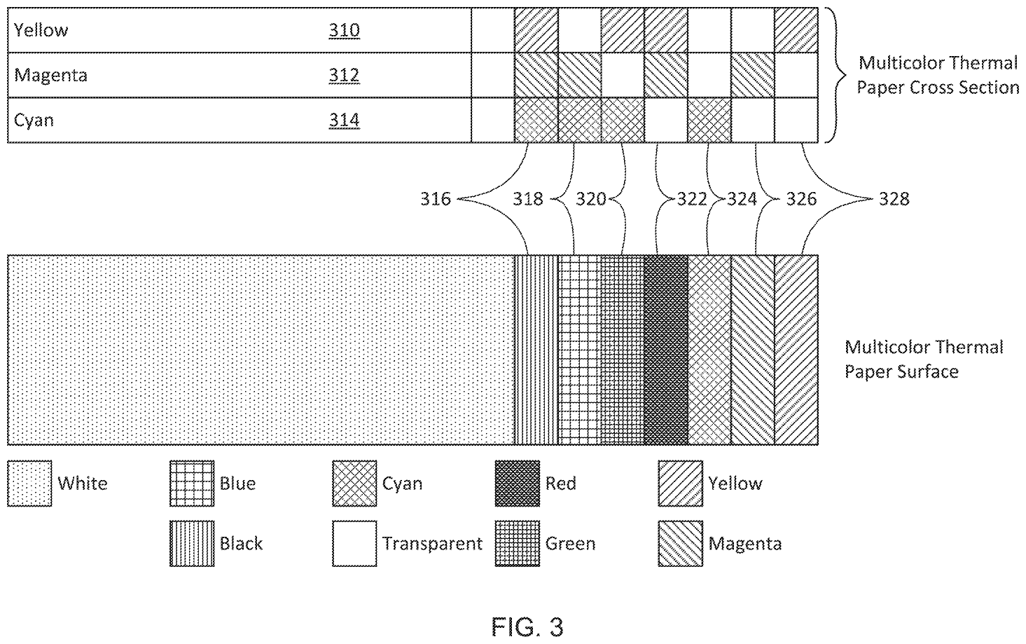

FIG. 3 illustrates an example of a cross-section and the surface of a sheet of multicolor thermal paper and a multiplicity of colors printed on it. In this example, the multicolor thermal paper comprises thermally activated dye layers for yellow 310, magenta 312, and/or cyan 314. In this example, combining various tones of cyan, magenta, and/or yellow, i.e., CMY, may be used to print a multiplicity of colors. In other examples, combining various tones of red, green, and/or blue, i.e., RGB, may be used to print a multiplicity of colors. Other color spaces and combinations of base or “primary” colors may also be used. The order of layers may also vary depending on the characteristics of materials used to generate the different colors.

In this example, combining tones of cyan, magenta, and/or yellow is done by activating the dye in one layer at a time. The multicolor thermal paper may be allowed to cool between the activation of each layer. Activating only the dye in the yellow layer 310 yields a yellow tone 328. Activating only the dye in the magenta layer 312 yields a magenta tone 326. Activating only the dye in the cyan layer 310 yields a cyan tone 324.

In this example, other colors are generated by the rules of the CMY color space. For example, sequentially activating layers 310 and 312 yields a tone of red 322. Sequentially activating layers 310 and 314 yields a tone of green 320. Similarly, sequentially activating layers 312 and 314 yields a tone of blue 318. Likewise, sequentially activating layers 310, 312, and 314 yields a tone of black 316. Finally, activating none of the layers 310, 312, and 314 of dye results in the color white. In some examples, multicolor thermal paper with three colors is used to print a gamut of different colors by vertically mixing colors activated in different layers or by dithering different ratios of the three colors.

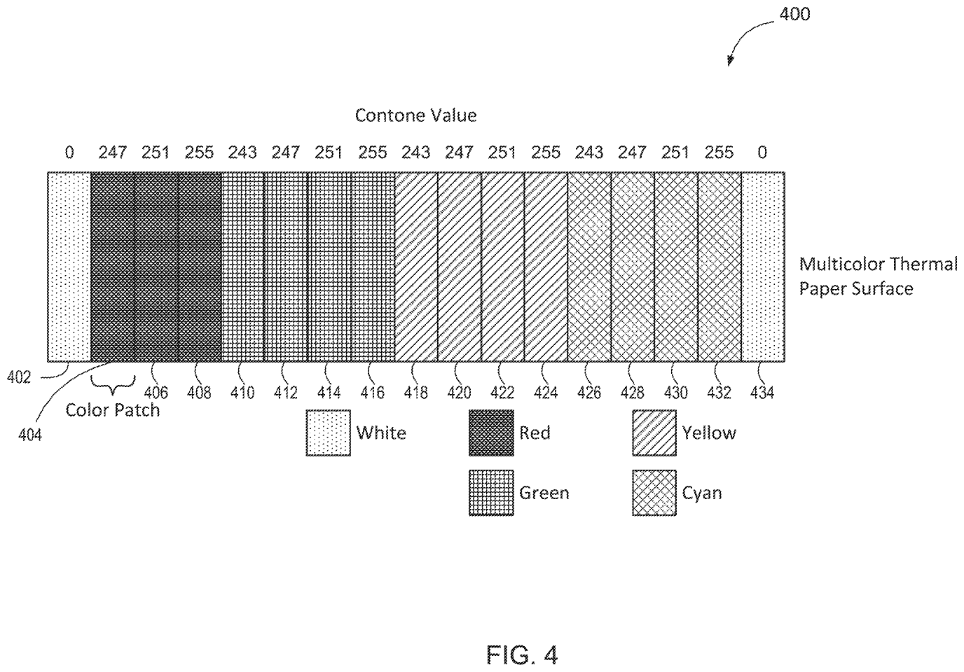

FIG. 4 illustrates an example calibration target 400 with a set of color patches of different discrete contones of each of a plurality of colors. In the illustrated example, there are 15 color patches 404, 406, 408, 410, 412, 414, 416, 418, 420, 422, 424, 426, 428, 430, and 432. Specifically, the color calibration target 400 includes three red color patches 404, 406, and 408 with contone values of 247, 251, and 255, respectively. The calibration target 400 also includes four green color patches 410, 412, 414, and 416 with contone values of 243, 247, 251, and 255, respectively. The calibration target 400 includes also includes four yellow color patches 418, 420, 422, and 424 with contone values of 243, 247, 251, and 255, respectively. The calibration target 400 also includes four cyan color patches 426, 428, 430, and 432 with contone values of 243, 247, 251, and 255, respectively. Finally, the calibration target 400 includes white areas 402 and 434 on both ends of the calibration target.

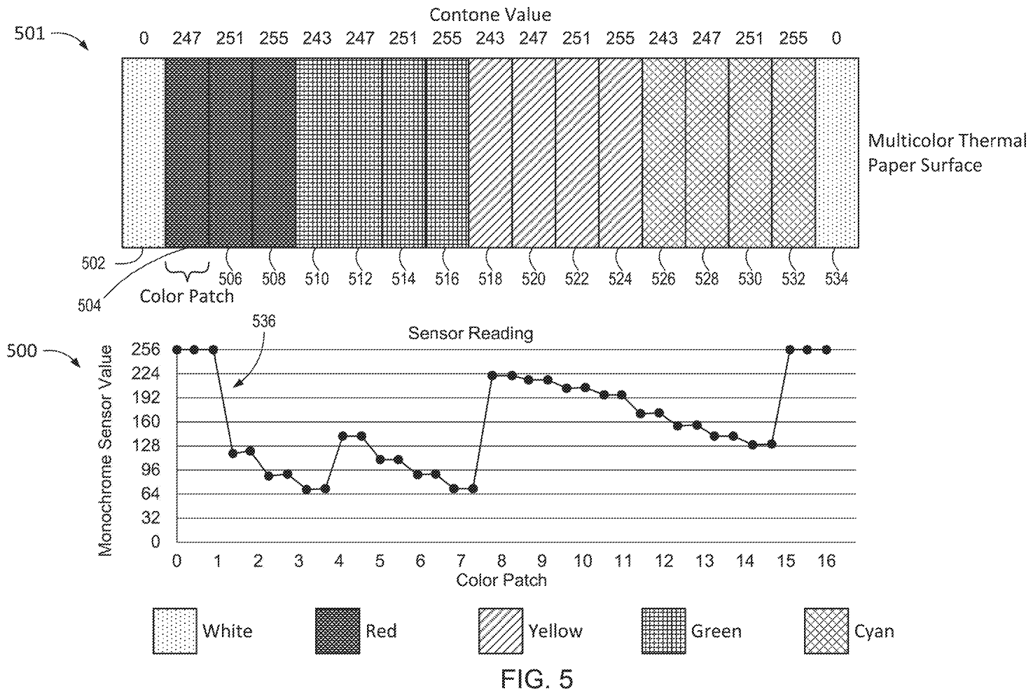

FIG. 5 illustrates an example graph 500 of monochrome lightness values of each color patch of a calibration target 501. In the illustrated example, the calibration target 501 includes 15 color patches 504, 506, 508, 510, 512, 514, 516, 518, 520, 522, 524, 526, 528, 530, and 532. Specifically, the calibration target 501 includes three red color patches 504, 506, and 508 with contone values of 247, 251, and 255, respectively. The calibration target 501 includes four green color patches 510, 512, 514, and 516 with contone values of 243, 247, 251, and 255, respectively. The calibration target 501 includes four yellow color patches 518, 520, 522, and 524 with contone values of 243, 247, 251, and 255, respectively. The calibration target 501 also includes four cyan color patches 526, 528, 530, and 532 with contone values of 243, 247, 251, and 255, respectively. Finally, the calibration target 501 includes two white areas 502 and 534 on both ends of the calibration target.

In the illustrated example, the monochrome lightness value (Y-axis of graph 500) of each color patch and the two white areas 502 and 534 are obtained from a monochrome lightness sensor. As illustrated, the monochrome lightness value of the white areas is 255. The red color patches 504, 506, and 508 have monochrome lightness values of approximately 128, 96, and 64. The green color patches 510, 512, 514, and 516 have monochrome lightness values of approximately 145, 110, 96, and 64. The yellow color patches 518, 520, 522, and 524 have monochrome lightness values of approximately 224, 218, 200, and 192. Finally, the cyan color patches 526, 528, 530, and 532 have monochrome lightness values of approximately 170, 160, 145, and 128.

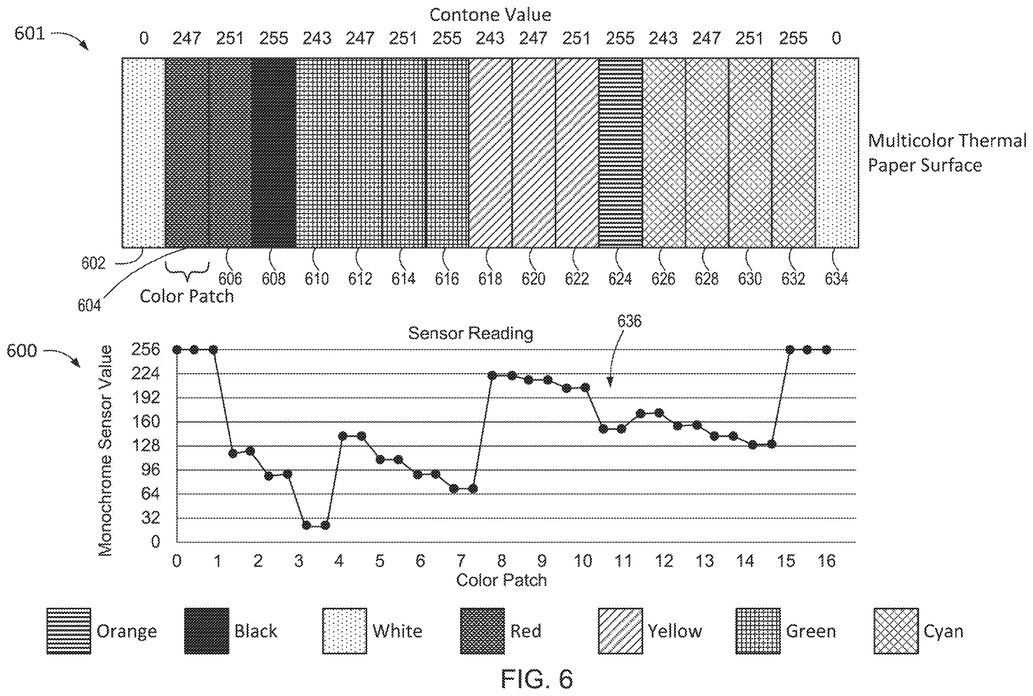

FIG. 6 illustrates an example graph 600 of monochrome lightness values of each color patch of a calibration target 601 where color crosstalk occurs. In the illustrated example, the calibration target 601 includes 15 color patches 604, 606, 608, 610, 612, 614, 616, 618, 620, 622, 624, 626, 628, 630, and 632. In the illustrated example, the calibration target 601 should include three red color patches 604, 606, and 608 with contone values of 247, 251, and 255, respectively. The calibration target 601 includes four green color patches 610, 612, 614, and 616 with contone values of 243, 247, 251, and 255, respectively. Additionally, the calibration target 601 should include four yellow color patches 618, 620, 622, and 624 with contone values of 243, 247, 251, and 255, respectively. Finally, the calibration target 601 includes four cyan color patches 626, 628, 630, and 632 with contone values of 243, 247, 251, and 255, respectively. There are two white areas 602 and 634 on both ends of the calibration target.

In the illustrated example, the monochrome lightness value in the graph 600 of each color patch (and the two white areas 602 and 634) of the calibration target 601 are obtained from the monochrome lightness sensor. In this example, the monochrome lightness value of the white areas is 255. The red color patches 604, 606, and 608 have monochrome lightness values of approximately 128, 96, and 30. The green color patches 610, 612, 614, and 616 have monochrome lightness values of approximately 145, 110, 96, and 64. The yellow color patches 618, 620, 622, and 624 have monochrome lightness values of approximately 224, 218, 200, and 150. Finally, the cyan color patches 626, 628, 630, and 632 have monochrome lightness values of approximately 170, 160, 145, and 128.

In the illustrated example, numerous colors are produced by combining tones of cyan, magenta, and/or yellow. Sequentially activating dye in one or more layers produces these combinations. The multicolor thermal paper is allowed to cool between the activation of each layer. However, due to variability in multicolor thermal paper and/or thermal printhead characteristics, the thermal printhead may inadvertently activate dyes in more than one layer at a time for some colors and contone values. When this occurs, additional unwanted color is added to an image, i.e., color crosstalk.

For example, the color patch 608 on the calibration target 601 was intended to be a red tone with a contone value of 255 and a monochrome lightness value of approximately 64. However, due to variability in multicolor thermal paper and/or thermal printhead characteristics, the printhead unintentionally activated dye in the cyan layer while attempting to activate only the dye within the magenta layer. In this example, the resulting color is a tone is closer to black and has a monochrome lightness value of less than 30.

In another example, the color patch 624 on the calibration target 601 was intended to be a yellow tone with a contone value of 255 and a monochrome lightness value of approximately 192. However, due to variability in multicolor thermal paper and/or thermal printhead characteristics, the printhead unintentionally activated dye in the magenta layer while attempting to activate only the dye within the yellow layer. In this example, the resulting color was an orange tone with a monochrome lightness value of approximately 150.

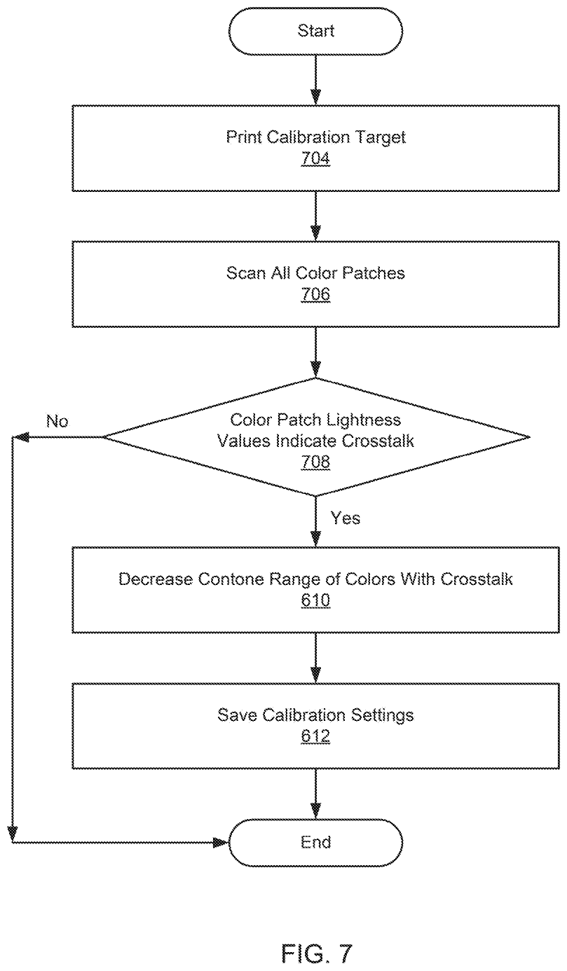

FIG. 7 illustrates an example process to calibrate a multicolor thermal printing system to improve image quality using a calibration target. In this example, a calibration subsystem prints, at 704, a calibration target. A monochrome lightness sensor scans, at 706, all color patches on the calibration target. In examples in which the monochrome lightness sensor is on the same side as the printhead, the calibration target may be scanned as it is printed the first time. In examples in which the monochrome lightness sensor is on the opposite side from printhead, a notification subsystem may prompt a user to reload the image with the multicolor thermal paper upside down after the image is printed so that the monochrome lightness sensor can measure the lightness values as it is passed through the printer again.

Once the color patches are scanned, at 706, a calibration subsystem evaluates, at 708, the monochrome lightness values for each color patch to determine if color crosstalk is present. If color crosstalk is present, the calibration subsystem decreases, at 710, the contone range for the color experiencing color crosstalk. The calibration subsystem then saves, at 712, the new calibration settings. In some examples, new calibration settings are saved to an ink separation map. If color crosstalk is not present, adjustments may not need to be made or saved.

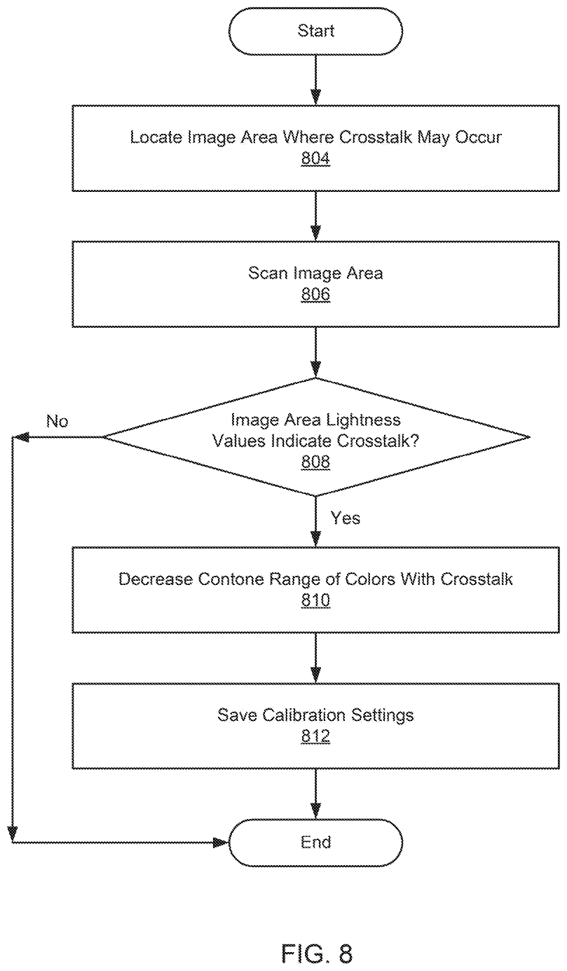

FIG. 8 illustrates an example process to calibrate a multicolor thermal printing system to improve image quality using an image. In this example, a calibration subsystem locates, at 804, areas within an image where color crosstalk may occur. A monochrome lightness sensor scans, at 806, identified image areas. A calibration subsystem evaluates, at 808, the monochrome lightness values for each image area to determine if color crosstalk is present. If color crosstalk is present, the calibration subsystem decreases, at 810, the contone range for the color experiencing color crosstalk. For instance, the multicolor thermal printer may be adapted to use a lower maximum contone value the color exhibiting crosstalk. In some examples, the calibration subsystem may modify an ink separation map used by the multicolor thermal printer to reduce the maximum contone values used for a print color. The calibration subsystem then saves, at 812, the new calibration settings. In some examples, new calibration settings are saved to an ink separation map. If color crosstalk is not present, no adjustments are made or saved.

Specific examples and applications of the disclosure are described above and illustrated in the figures. It is, however, understood that many adaptations and modifications can be made to the precise configurations and components detailed above. In some cases, well-known features, structures, or operations are not shown or described in detail. Furthermore, the described features, structures, or operations may be combined in any suitable manner in one or more examples. It is also appreciated that the components of the examples as generally described and illustrated in the figures herein could be arranged and designed in a wide variety of different configurations. Thus, all feasible permutations and combinations of examples are contemplated.

In the description above, various features are sometimes grouped together in a single example, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed example. Thus, the claims are hereby expressly incorporated into this Detailed Description, with each claim standing on its own as a separate example. This disclosure includes all permutations and combinations of the independent claims with their dependent claims.

It will be apparent to those having skill in the art that changes may be made to the details of the above-described examples without departing from the underlying principles of the invention.

What is claimed is:

1. A multicolor thermal printer, comprising:
a controller;
a thermal printhead in communication with the controller to print on multicolor thermal paper;
a sensor to measure a monochrome lightness value; and
a calibration subsystem to:
print, via the thermal printhead, a calibration target with set of color patches of different discrete contones of each of a plurality of colors,
scan, via the sensor, the calibration target to identify a monochrome lightness value of each color patch printed on the calibration target,
identify a color patch of one of the plurality of colors with a lightness value indicating color crosstalk with another color, and
adjust a color calibration setting to decrease an available contone range of the color of the identified color patch.

2. The multicolor thermal printer of claim 1, wherein the calibration subsystem further to scan the color calibration target as the calibration target is printed.

3. The multicolor thermal printer of claim 1, wherein the calibration subsystem scans the calibration target after the printed calibration target is reloaded into the multicolor thermal printer.

4. The multicolor thermal printer of claim 1, wherein the calibration target is printed with four sets of color patches for each of four different colors, wherein each set of color patches comprises at least three different discrete contones of each of the four different colors.

5. The multicolor thermal printer of claim 1, wherein the calibration subsystem adjusts the calibration setting by modifying an ink separation map used by the multicolor thermal printer.

6. A non-transitory computer-readable medium with instructions stored thereon that, when executed, cause a processor of a computing device, to:
print, via a multicolor thermal printer, a calibration target comprising a sequence of color patches including:
a first set of color patches of different discrete contones of a first color,
a second set of color patches of different discrete contones of a second color, and
scan, via a sensor, the calibration target;
determine a lightness value for each scanned color patch in the sequence of color patches on the calibration target;
identify a scanned color patch with a lightness value that indicates color crosstalk between two colors; and
calibrate the multicolor thermal printer to use a lower maximum contone for the color of the identified color patch that indicates the color crosstalk between the two colors.

7. The non-transitory computer-readable medium of claim 6, wherein the first set of color patches includes at least three color patches of different discrete contones of the first color, and
wherein the second set of color patches includes at least three color patches of different discrete contones of the second color.

8. The non-transitory computer-readable medium of claim 6, wherein the instructions cause the processor of the computing device to calibrate the multicolor thermal printer by modifying an ink separation map used by the multicolor thermal printer.

9. The non-transitory computer-readable medium of claim 6, wherein the sequence of color patches printed on the calibration target further comprises a third set of color patches of different discrete contones of a third color.

10. The non-transitory computer-readable medium of claim 9, wherein the third set of color patches includes at least three color patches of different discrete contones of the third color.

11. The non-transitory computer-readable medium of claim 9, wherein the sequence of color patches printed on the calibration target further comprises a fourth set of color patches of different discrete contones of a fourth color.

12. The non-transitory computer-readable medium of claim 11, wherein the multicolor thermal printer prints the calibration target on three-color thermal paper, and wherein one of the four sets of color patches comprises a dithered pattern of two colors.

13. A multicolor thermal printer, comprising:
a controller;
a thermal printhead in communication with the controller to print on multicolor thermal paper;
a sensor to measure a monochrome lightness value; and
a calibration subsystem to:
identify an area of an image to be printed with a constant contone of a first color;
identify an expected lightness value of the identified area based on the constant contone of the first color;
scan, via a sensor, the identified area of the image after the image is printed to measure a monochrome lightness value of the identified area,
compare the measured lightness value with the expected lightness value to identify color crosstalk between the first color and a second color; and
create new ink separation map that reduces an available maximum contone for at least one print color used to print the first color.

14. The multicolor thermal printer of claim 13, wherein the calibration subsystem scans the identified area of the image after the image is printed and reloaded into the multicolor thermal printer.

15. The multicolor thermal printer of claim 13, wherein the multicolor thermal printer further comprises a notification subsystem to prompt a user to reload the image after the image is printed.
